(19) United States
(12) Patent Application Publication
(10) Pub. No.: US 2013/0108105 A1
(43) Pub. Date: May 2, 2013

(54) APPARATUS AND METHOD FOR MASKING PRIVACY REGION BASED ON MONITORED VIDEO IMAGE

(71) Applicants: Jang Hee YOO, Daejeon (KR); Han Sung LEE, Yongin (KR); Jong Gook KO, Daejeon (KR)

(72) Inventors: Jang Hee YOO, Daejeon (KR); Han Sung LEE, Yongin (KR); Jong Gook KO, Daejeon (KR)

(73) Assignee: Electronics and Telecommunications Research Institute, Daejeon (KR)

(21) Appl. No.: 13/565,347

(22) Filed: Aug. 2, 2012

(30) Foreign Application Priority Data
Oct. 31, 2011 (KR) 10-2011-0112116

(51) Int. Cl. G06K 9/46

(52) U.S. Cl. 382/103

(57) ABSTRACT

Disclosed are a method and an apparatus for masking a privacy region based on a monitored video image. The method for masking a privacy region based on a monitored video image, includes: extracting a target object from the video input from an video collector to detect a privacy masking region from the extracted target object; and graphic-processing only the detected privacy masking region of the target object to hide the privacy masking region without transforming an original of the input video, thereby easily hiding the privacy region without transforming original video captured when monitoring an video image of a monitoring target region not to expose the privacy region.

### CROSS-REFERENCE TO RELATED APPLICATIONS

This application claims priority to and the benefit of Korean Patent Application No. 10-2011-0112116 filed in the Korean Intellectual Property Office on Oct. 31, 2011, the entire contents of which are incorporated herein by reference.

### TECHNICAL FIELD

The present invention relates to a method and an apparatus for masking a privacy region based on a monitoring video image.

### BACKGROUND ART

In recent years, various methods for masking personal important information such as a face or a license plate of a vehicle in a closed-circuit television (CCTV) environment have been developed. However, a method of scrambling or encrypting a CCTV video in a detected object region using an existing object detecting method, that is, methods of transforming video image and then restoring the transformed video image as needed have been mainly used.

Unidirectional encryption is possible in the methods for masking personal important information as described above. However, the methods for masking important privacy information have a problem in that decoding an encryption region is impossible or separate metadata for the decoding need to be maintained.

Accordingly, there is a need for the development of a technology capable of more efficiently masking privacy region without transforming original image with respect to an important region associated with private information such as a face or a license plate of a vehicle detected from CCTV video image.

### SUMMARY OF THE INVENTION

The present invention has been made in an effort to provide a method and an apparatus for masking a privacy region such that the privacy region is not exposed without transforming an originally captured video when monitoring a video image of a monitoring target region.

An exemplary embodiment of the present invention provides a method for masking a privacy region based on a monitored video image, including: extracting a target object from the video input from a video collector to detect a privacy masking region from the extracted target object; and graphic-processing only the detected privacy masking region of the target object to hide the privacy masking region without transforming an original of the input video.

The method for masking a privacy region may further include storing a transmission video from the video collector in a storage unit before graphic-processing the privacy masking region of the input video image.

The method for masking a privacy region may further include encrypting or scrambling the video from the video collector before transmitting the transmission image to the storage unit.

The method for masking a privacy region may further include decoding the encrypted video before detecting the privacy masking region.

The detecting of the privacy masking region may include detecting or tracking a fixed object such as a face of a standing human or a license plate of a standing vehicle and a moving object such as a moving vehicle or human as a target object.

The hiding of the privacy masking region may include recognizing and classifying the detected target object based on a preset standard and determining a range of a target to be hidden as the privacy masking region based on the recognized and classified result.

The detecting of the privacy masking region may include estimating a moving region of the target object with respect to all frames of the input video based on an object track algorithm such as a Kalman filter, a Particle filter, a Bayesian filter, or characteristic extraction to track and detect the target object.

Another exemplary embodiment provides an apparatus for masking a privacy region based on a monitored video image, including: a target detecting unit detecting a privacy masking region from input video image through an video collector; and a privacy region masking unit graphic-processing and hiding only the detected privacy masking region without transforming original video of the input video.

The apparatus may further include a storage unit storing output video image of the video collector before graphic-processing the privacy masking region.

The input video may be encrypted by an encrypting unit immediately after output in the video collector, and may be decoded by a decoding unit before being input to a target detecting unit.

The target detecting unit may include: an object detector detecting a fixed object such as a face of a standing human or a license plate of a vehicle or a moving object such as a moving vehicle or human as a target object; and an object tracker estimating a moving region of the moving object based on an object track algorithm such as a Kalman filter, a Particle filter, a Bayesian filter, or characteristic extraction when the target object is the moving object to track the moving object.

The privacy region masking unit may include: a hiding target setter recognizing the detected target object based on an object recognition algorithm and determining the recognized target object as a target object for masking a privacy region according to preset classification criterions; and a hiding processor hiding a privacy masking region using a graphic processing method without transforming the original video with respect to the determined target object.

In a method and an apparatus for masking a privacy region based on monitoring video image according to exemplary embodiments of the present invention, it is possible to easily hide an important region associated with privacy from video input through a camera for monitoring the video image using a graphic method without transforming original video.

In the method and the apparatus for masking a privacy region based on monitoring video image according to exemplary embodiments of the present invention, it is possible to hide an important region associated with a privacy from video input through a camera for monitoring the video image using a graphic method without performing an additional meta data file generating procedure or unmasking procedure.

In the method and the apparatus for masking a privacy region based on monitoring video image according to exemplary embodiments of the present invention, it is possible to designate a hiding stage of an important region associated with privacy in a system level.

In the method and the apparatus for masking a privacy region based on monitoring video image according to exemplary embodiments of the present invention, it is possible to set a security class with respect to a monitoring device or system when hiding an important region associated with a privacy, which leads to an efficiently increasing efficiency of a system through security of private information.

In the method and the apparatus for masking a privacy region based on monitoring video image according to exemplary embodiments of the present invention, it is possible to restrict access authority for monitoring encrypted video to a monitoring device, thereby performing various levels of hiding and securing authority with respect to the privacy region.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a flowchart illustrating a method for masking a privacy region based on a monitored video image according to an exemplary embodiment of the present invention.

FIG. 2 is a block diagram illustrating a configuration of an apparatus for masking a privacy region based on a monitored video image according to the exemplary embodiment of the present invention.

FIG. 3A, 3B are diagram illustrating an example in which a privacy region is masked from a monitored video image when the exemplary embodiment of the present invention is applied.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

The present invention may include various modifications and exemplary embodiments, and thus specific exemplary embodiments are exemplified in the drawings and will be described.

However, the present invention is not limited to the specific exemplary embodiment, but it should be construed that the present invention includes all modifications, equivalents, and substitutes belonging to the scope of the present invention without departing from the spirit of the present invention.

Although terms “first” and “second” are used to describe various components, the components should not be limited to the terms. The terms “first” and “second” are used to distinguish similar elements from each other. Accordingly, a first component may be named a second component without departing from the scope of the present invention. Similarly, the second component may be named the first component. A term “and/or” represents the combination of a plurality of items or one of the items.

When a component is referred to as being “connected to” or “linked to” another component, the component may be directly connected to or linked to another component or an intervening component may be present therebetween. In contrast, if a component is referred to as being “directly connected to” or “directly linked to” another component, an intervening component may not be present therebetween.

The terms used in the specification are for the purpose of explaining specific exemplary embodiments and have no intention to limit the present invention. Unless the context indicates otherwise, the singular expression may include the plural expression. In the following description, the term “include” or “has” will be used to refer to the feature, the number, the step, the operation, the component, the part or the combination thereof without excluding the presence or addition of one or more features, the numbers, the steps, the operations, the components, the parts or the combinations thereof.

Unless defined otherwise, all the terms including technical and scientific terms used in this specification may have the meaning that can be commonly apprehended by those skilled in the art. The terms, such as the terms defined in the commonly-used dictionary, must be interpreted based on the context of the related technology and must not be interpreted ideally or excessively.

Hereinafter, exemplary embodiments will be described in more detail with reference to accompanying drawings. In the following description, for the illustrative purpose, the same components will be assigned with the same reference numerals, and the repetition in the description about the same components will be omitted in order to avoid redundancy.

In an exemplary embodiment of the present invention, CCTV video monitoring systems ensuring public peace and order and safety have been rapidly supplied and installed. In recent years, such systems tend to rapidly increase physical information collectable in a remote location, for example, through high definition and high magnification. However, the systems have a problem in that important information such as a personal privacy or face, and a vehicle number can be easily exposed in a high performance image monitoring environment.

To solve such problems, in the present invention, a CCTV video monitoring system encrypts, transmits, and stores video input through an video collector (for example, camera), such that monitoring for the stored video image is restricted by a device for masking a privacy region including a decoding procedure, and a monitoring device or system detects and tracks an object of a monitored video image, efficiently hides a region for which protection of the privacy is required by a graphic method without transforming an original video, and stores an originally encrypted video without damaging or transforming the video upon storage to efficiently achieve a purpose of privacy protection without an unmasking procedure.

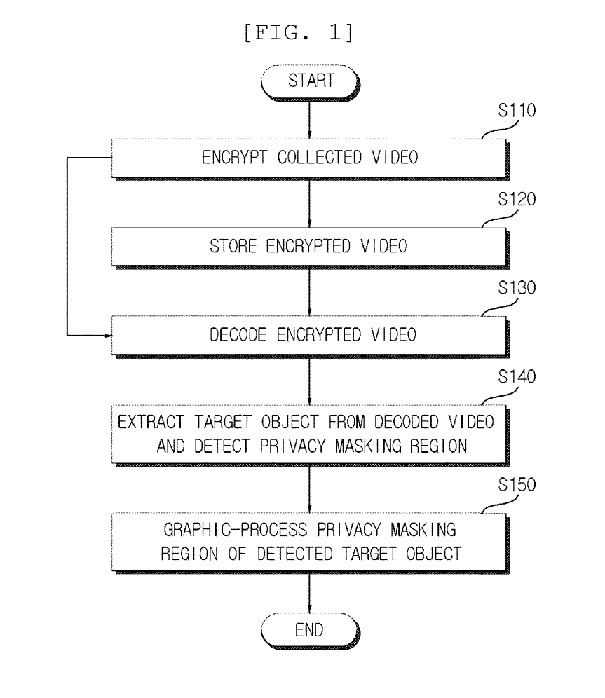

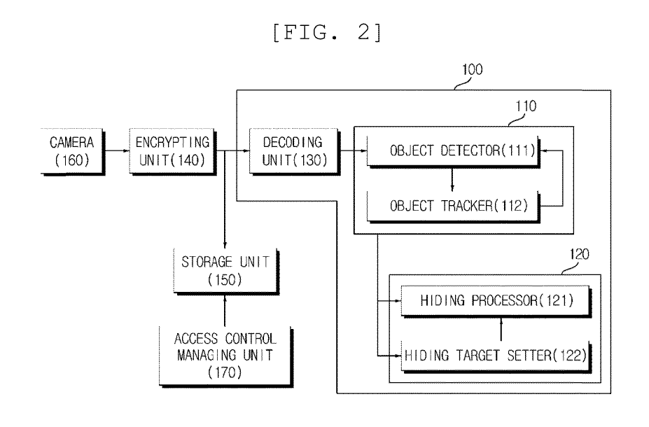

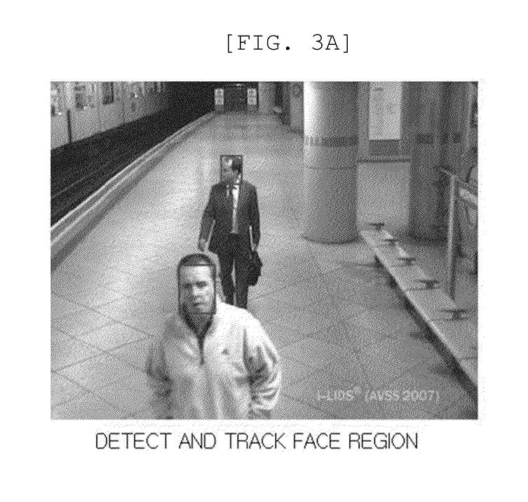

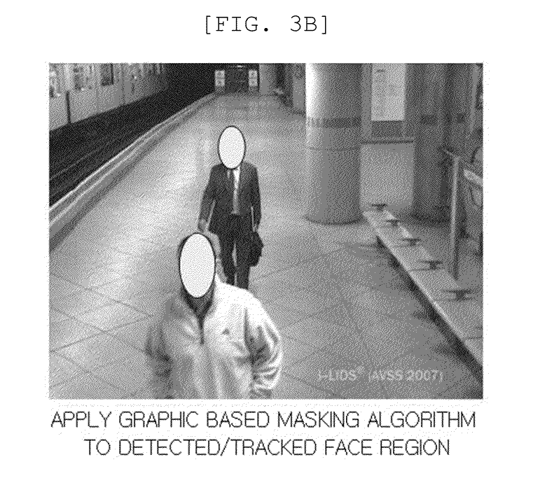

FIG. 1 is a flowchart illustrating a method for masking a privacy region based on a monitored video image according to an exemplary embodiment of the present invention; FIG. 2 is a block diagram illustrating a configuration of an apparatus for masking a privacy region based on a monitored video image according to the exemplary embodiment of the present invention; and FIG. 3 is a diagram illustrating an example in which a privacy region is masked from a monitored video image when the exemplary embodiment of the present invention is applied.

Hereinafter, referring to FIGS. 1 to 3, the method and the apparatus for masking a privacy region based on a monitored video image according to the exemplary embodiment of the present invention will be described in detail.

First, referring to FIG. 2, the apparatus for masking a privacy region based on a monitored video image according to the exemplary embodiment of the present invention may include a target detecting unit 110 detecting a privacy masking region from an input video through an video collector, and a privacy region masking unit 120 graphic-processing and hiding only the privacy masking region without transforming an original video of the input video.

The apparatus for masking a privacy region may further include a storage unit 150 storing an output video of the video collector such as a camera 160 before graphic-processing the privacy masking region; an encrypting unit 140 encrypting the output video of the video collector; and a decoding unit 130 decoding the encrypted output video before the encrypted output video is input to the target detecting 110 of a monitoring device 100.

A secure mechanism may be efficiently designed such that a non-hidden video is stored in the storage unit 150, and accesses with respect to a separately stored video is managed in the stored video by an access control managing unit 170.

In the present exemplary embodiment, the target detecting unit 110, the privacy region masking unit 120, and the decoding unit 130 are included inside the monitoring device 100. This is an exemplary embodiment. However, the present invention is not limited by locations of the foregoing constituent elements.

The target detecting unit 110 may include an object detector 111 detecting a fixed object such as a face of a standing human or a license plate of a standing vehicle and a moving object such as a moving vehicle or human as a target object; and an object tracker 112 estimating a moving region of the moving object based on an object track algorithm such as a Kalman filter, a Particle filter, a Bayesian filter, or characteristic extraction when the target object is the moving object to track the moving object.

The privacy region masking unit 120 may include a hiding target setter 122 recognizing the detected target object based on an object recognition algorithm and determining the recognized target object as a target object for masking a privacy region according to a preset classification criterions; and a hiding processor 121 hiding a privacy masking region using a graphic processing method without transforming the original video with respect to the determined target object.

The method and the apparatus for masking a privacy region based on a monitored video image according to the exemplary embodiment of the present invention aim at safe transmission and management of an video input from a CCTV camera and masking a privacy region of an object such as a face region of a human, a vehicle license plate region, and a window region. That is, in the method and the apparatus for masking a privacy region based on a monitored video image according to the exemplary embodiment of the present invention, an apparatus or system for monitoring a CCTV video detects and tracks a region in order to mask information is required such as a face region, a window region, or a license plate region, hide the detected and tracked region in only the monitoring device 110 using a graphic method without transforming the video, applies an encryption method to the region transmitted and stored in the storage unit 150 without changing characteristics of an original video, and transmits and stably stores the encrypted video.

With reference to FIGS. 1 and 2, an operation of the apparatus for masking a privacy region based on a monitored video image according to the exemplary embodiments of the present invention will be described in detail.

An encrypting unit 140 encrypts a collected original video input from a video collector such as a CCTV or a camera 160 through an encrypting procedure or a scrambling procedure as needed to stably transmit and store the collected original video (S110). The encryption of the original video is performed to prevent opening of a privacy region due to discharge of the original video in a next transmission procedure.

In the encrypting step 5110, the scrambling of the privacy region of the original video may be performed using a scrambling key. For example, the scrambling may be performed by applying y=Kx (where, K is an image before scrambling, y is a scrambling key, and x is the image after scrambling).

The encrypted original video is either transmitted to the monitoring device 100, or sent to the storage unit 150 and stored in the storage unit 150 (S120).

The decoding unit 130 receives and decodes the encrypted video from the encrypting unit 140 to restore the original video from the encrypted video for detecting an object or hiding the privacy region in a following procedure (S130).

The target detecting unit 110 extracts a target object from the decoded original video and detects a privacy masking region from the extracted target object (S140). The privacy region masking unit 120 graphic-processes only the detected privacy masking region to hide the privacy masking region of the target object without transforming the received original video (S150).

In detail, the object detector 111 performs a detecting procedure with respect to a privacy region such as a face for hiding the privacy region from the decoded original video using various methods or algorithms specified in object detection such as a face detection algorithm or a license plate detection algorithm in regional detection such as a face and a license plate. The object tracker 112 tracks a target object using a moving object detection algorithm when it is difficult to detect the target object due to rapid movement or sudden activity of the target object upon detecting the object.

Since the object tracker 111 needs to process all frames of the video upon hiding the privacy region, the object tracker 111 estimates a moving region of an object based on various object track algorithms such as a Kalman filter, a Particle filter, a Bayesian filter, characteristic extraction to improve speed and reliability with respect to detection of the object.

The hiding processor 121 hides a privacy region, namely, with respect to a region for which a privacy masking detected through a previous procedure is required using a separate graphic processing method without transforming the original video (S150). The hiding target setter 122 may hide a privacy region of a selectively detected object by operative cooperation with an algorithm classifying a detected object.

For example, when a face capable of identifying a human and a license plate capable of identifying a vehicle are included in the original video, a face region and a license plate region may be detected for hiding a privacy region. The privacy region may be detected using at least one of edge information, shape information, and color distribution information of the original video and machine learning data of the privacy region.

That is, the edge information may be acquired through analysis for the original video, and a boundary between the face and parts except for the face may be detected using the edge information. The analyzed result for the video image may be compared with shape information such as a face shape to determine whether the face is included in the image. Because the color distribution information may be compared with unique color distribution information of the face, the face region may be more exactly detected. The face region may be detected using the machine learning data of the privacy region including an Adaboost learning algorithm.

FIGS. 3A and 3B shows an example of a hiding processing using face detection and tracking by the monitoring device 100 or system. When an important region such as a face for masking is set, the hiding process is applicable using various characters and meaningful graphic symbols according to a size of the region based on the set region.

As described above, the exemplary embodiments have been described and illustrated in the drawings and the specification. The exemplary embodiments were chosen and described in order to explain certain principles of the invention and their practical application, to thereby enable others skilled in the art to make and utilize various exemplary embodiments of the present invention, as well as various alternatives and modifications thereof. As is evident from the foregoing description, certain aspects of the present invention are not limited by the particular details of the examples illustrated herein, and it is therefore contemplated that other modifications and applications, or equivalents thereof, will occur to those skilled in the art. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. A method for masking a privacy region based on a monitored video image, including:
extracting a target object from the video input from an video collector to detect a privacy masking region from the extracted target object; and
graphic-processing only the detected privacy masking region of the target object to hide the privacy masking region without transforming an original of the input video.

2. The method of claim 1, further comprising:
storing a transmission video from the video collector in a storage unit before graphic-processing the privacy masking region of the input video.

3. The method of claim 2, further comprising:
encrypting or scrambling the video from the video collector before transmitting the transmission video image to the storage unit.

4. The method of claim 3, further comprising:
decoding the encrypted video before detecting the privacy masking region.

5. The method of claim 1, wherein the detecting of the privacy masking region includes detecting or tracking a fixed object such as a face of a standing human or a license plate of a standing vehicle and a moving object such as a moving vehicle or human as the target object.

6. The method of claim 5, wherein the hiding of the privacy masking region includes recognizing and classifying the detected target object based on a preset standard and determining a range of a target to be hidden as the privacy masking region based on the recognized and classified result.

7. The method of claim 5, wherein the detecting of the privacy masking region includes estimating a moving region of the target object with respect to all frames of the input video based on an object track algorithm such as a Kalman filter, a Particle filter, a Bayesian filter, or characteristic extraction to track and detect the target object.

8. An apparatus for masking a privacy region based on a monitored video image, comprising:
a target detecting unit detecting privacy masking region from the video input through the video collector and
a privacy region masking unit graphic-processing and hiding only the privacy masking region without transforming original of the input video.

9. The apparatus of claim 8, further comprising:
a storage unit storing an output video of the video collector before graphic-processing the privacy masking region.

10. The apparatus of claim 9, wherein the input video are encrypted by an encrypting unit immediately after output in the video collector, and are decoded by a decoding unit before being input to the target detecting unit.

11. The apparatus of claim 10, wherein the target detecting unit includes:
an object detector detecting a fixed object such as a face of a standing human or a license plate of a vehicle or a moving object such as a moving vehicle or a human as a target object; and
an object tracker estimating a moving region of the moving object based on an object track algorithm such as a Kalman filter, a Particle filter, a Bayesian filter, or characteristic extraction when the target object is the moving object to track the moving object.

12. The apparatus of claim 11, wherein the privacy region masking unit includes:
a hiding target setter recognizing the detected target object based on an object recognition algorithm and determining the recognized target object as a target object for masking a privacy region according to a preset classification criterions; and
a hiding processor hiding a privacy masking region using a graphic processing method without transforming the original video with respect to the determined target object.
